(19) United States
(12) Patent Application Publication
(10) Pub. No.: US 2005/0088654 A1
(43) Pub. Date: Apr. 28, 2005

(54) Apparatus for combining multiple lasers and methods of use

(75) Inventors: Wentao Hu, Centereach, NY (US); Qiang Fu, Dix Hills, NY (US); Mark V. Ortiz, Shoreham, NY (US)

Correspondence Address: DARBY & DARBY P.C., P. O. BOX 5257, NEW YORK, NY, 10150-5257, US

(73) Assignee: Excel/Quantronix, Inc., East Setauket, NY (US)

(21) Appl. No.: 10/973,969

(22) Filed: Oct. 26, 2004

Related U.S. Application Data
(60) Provisional application No. 60/515,139, filed on Oct. 27, 2003.

(51) Int. Cl. G01N 21/00

(52) U.S. Cl. 356/432; 372/9

(57) ABSTRACT

A multi-headed laser apparatus combining a two or more lasers in a single housing with a single output beam. In addition to the housing, other components can be shared among the lasers such as the power supply, intracavity shutter, and excitation lamp. Additionally, the combination of two or more lasers with different characteristics makes possible a wide range of applications in the areas of materials processing and analysis, among others. A further multi-laser device is disclosed in which the wavelength of one or more of the lasers can be varied.

### RELATED APPLICATIONS

The present application claims priority from U.S. Provisional Patent Application No. 60/515,139, filed Oct. 27, 2003, which is incorporated herein by reference in its entirety.

### FIELD OF THE INVENTION

The present invention relates generally to lasers, and more particularly, to apparatus for combining multiple lasers and methods of using same.

### BACKGROUND INFORMATION

Individual lasers typically provide optimal performance over a given range of parameters thereby necessitating the use of different lasers for different applications. For example, infrared (IR) lasers are typically best suited for heating or cutting metals, ceramics and phenolic plastic, whereas deep ultraviolet (DUV) lasers are typically best suited for processing glass. In addition to wavelength, other parameters for which laser performance can be optimized include power, temporal mode of operation (e.g., continuous wave, pulsed or modulated), and spatial mode of operation (e.g., TEM₀₀, multimode or low order mode). Furthermore, gas-phase lasers and solid state lasers have different characteristics which may make one type better suited than the other for a given application.

It has been known to combine two or more identical lasers in a single housing. Such devices have been used, for example, in particle imaging velocimetry (PIV). For PIV applications, the two or more identical lasers are also beam-combined to share the same beam path. It has also been known to combine multiple different lasers in a single housing, such as the Coherent Versapulse C, which combines an IR, a green and 2.94 micron laser for medical applications. The various lasers in the Versapulse C are not beam-combined. Such combined devices, however, are designed for specific applications. Moreover, the types of lasers that can be combined are limited.

What is lacking is a platform that allows users to select from a wide variety of lasers and to combine any two or more selected lasers into a single housing with a single output beam.

### SUMMARY OF THE INVENTION

The present invention overcomes the above-described shortcomings of the prior art by combining two or more lasers selected from a wide variety of lasers into a single housing with a combined beam output. The result is a single device that can be tailored from a large matrix of parameters and features to provide optimal operation for one or more applications.

Additionally, the device of the present invention allows for combining components of the two or more lasers including the beam delivery sub-system, power supply, intra-cavity shutter, and laser excitation source. This reduces complexity, cost, and size.

In a further aspect of the present invention, novel applications in a variety of areas are made possible by the inventive apparatus. In materials processing, single and multiple-material systems can be advantageously processed using the laser apparatus of the present invention. For example, in a single-material system, one laser can used as a process initiator whereas a second laser can be used as a process driver. In materials analysis, a multi-laser apparatus of the present invention can be used to determine the composition of a material and to further determine the quality or grade of the material. The material analyzed can be inorganic or organic, including living tissue in medical applications.

These and other aspects of the present invention are described below.

### BRIEF DESCRIPTION OF THE DRAWINGS

FIG. 1 is a schematic illustration of an exemplary embodiment of a laser system in accordance with the present invention. FIG. 1A shows an exemplary embodiment of an intra-cavity shutter for use in the exemplary laser of FIG. 1.

FIG. 2 is a plan view showing the layout of components of the exemplary laser of FIG. 1.

FIGS. 3A-3C show exemplary arrangements of an excitation lamp and multiple oscillator rods for use in a multi-laser device of the present invention.

FIGS. 4A-4C illustrate exemplary combinations of the outputs of pulsed lasers.

FIG. 5 illustrates a ratiometric analysis method for analyzing materials using a dual-laser device of the present invention.

FIG. 6 is a schematic illustration of an exemplary embodiment of a laser system in accordance with the present invention.

### DETAILED DESCRIPTION

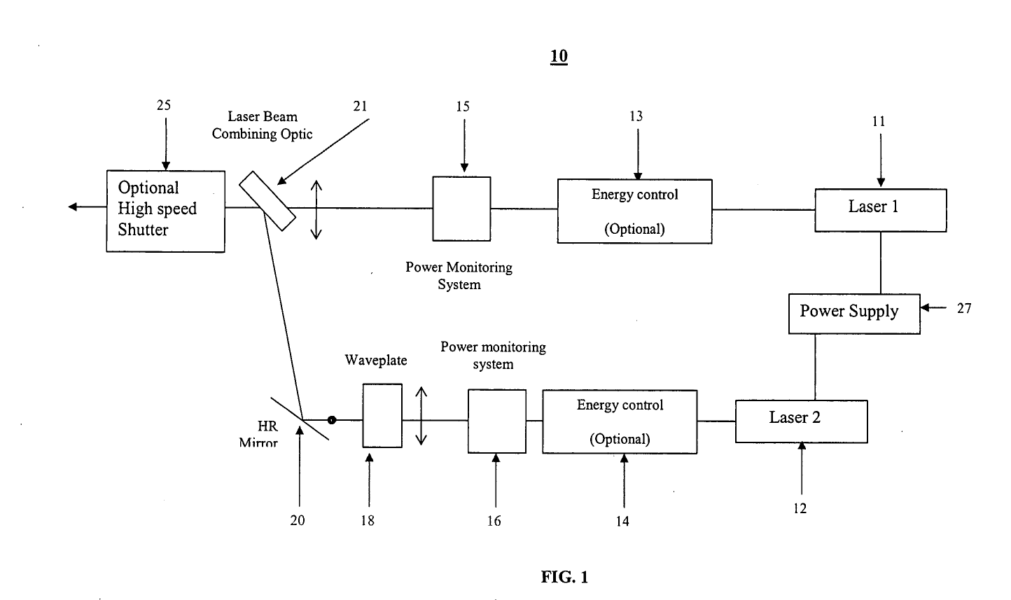

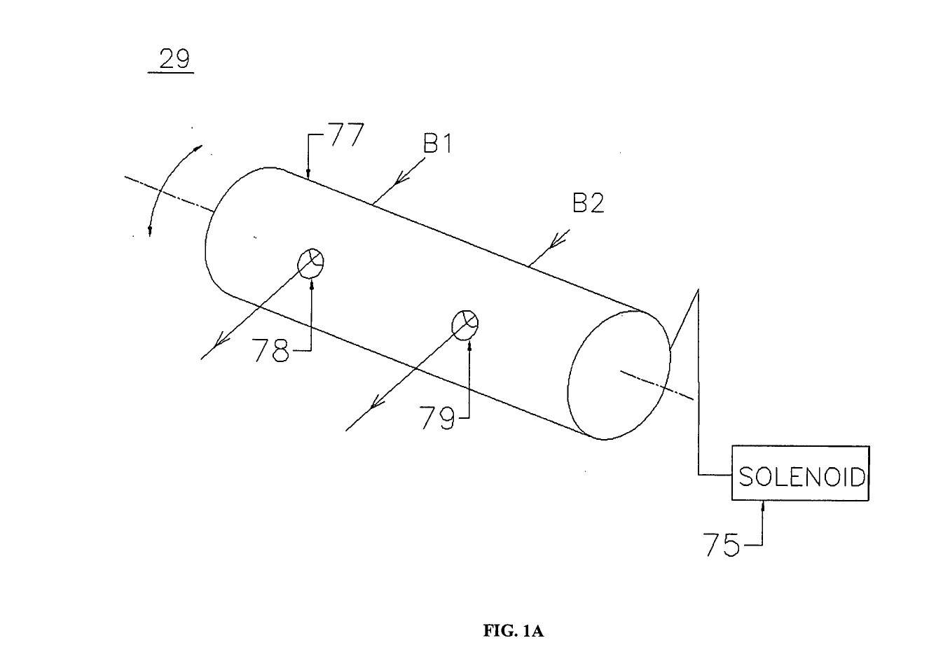

FIG. 1 is a schematic illustration of an exemplary embodiment of a multi-head laser system 10 in accordance with the present invention. The exemplary system 10 comprises two lasers 11 and 12, although other numbers of lasers are also possible within the scope of the present invention. Each laser 11, 12 may have respective energy control units 13, 14 and power monitoring systems 15, 16. The lasers are preferably triggered independently of each other.

The beams generated by the lasers 11, 12 are combined using a highly reflective (HR) mirror 20 and a laser beam combining optic 21. A waveplate 18 is included to rotate the polarization of one of the lasers by 90 degrees so that the lasers can be polarization combined into the same beam. In FIG. 1, the polarizations of the beams are indicated by arrows and dots along the beam paths. The combined beam may pass through a high speed shutter 25.

Where the wavelengths of the laser beams to be combined are different, they can be combined without polarization, in which case the waveplate 18 can be removed.

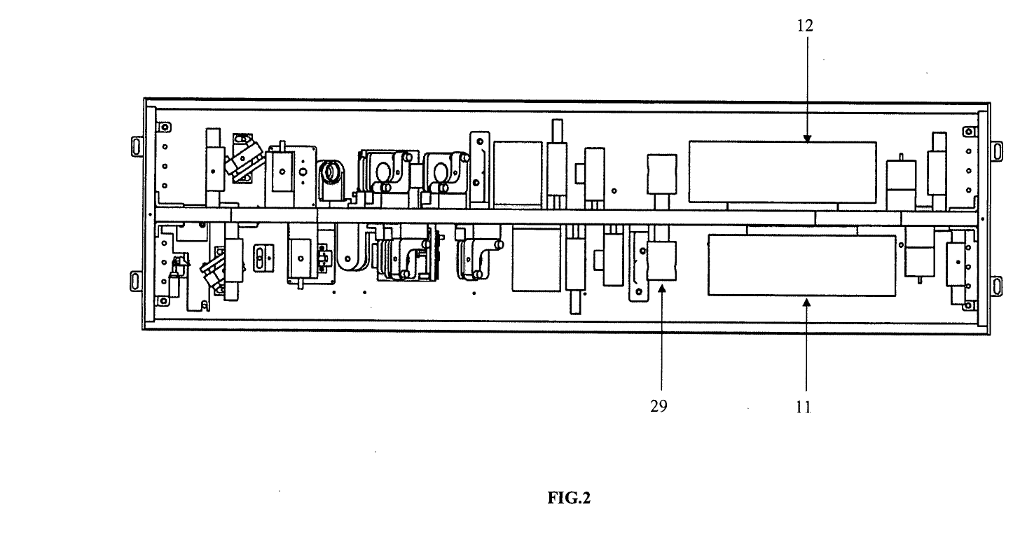

FIG. 2 is a plan view showing an exemplary layout of components of the exemplary system 10.

The lasers 11 and 12 can be selected from a wide variety of commercially available lasers, including the FALCON, EAGLE and CONDOR models of lasers from Quantronix Corporation of East Setauket, N.Y.

In addition to combining the housings of separate lasers into one housing, other components can be advantageously combined as well in accordance with the present invention. For example, the lasers 11 and 12 can share a common power supply 27. The excitation lamps of the lasers can be coupled in parallel or in series to the power supply. Furthermore, as shown in FIG. 2, an intracavity shutter device 29 with two shutters and with a common solenoid can be used. The intracavity shutter device 29 selectively blocks the beam paths of both lasers 11, 12, thereby turning off both lasers simultaneously. FIG. 1A shows an exemplary intracavity shutter device 29 having a rotary configuration which is activated by a solenoid 75. The solenoid 75 drives a generally cylindrical member 77 having an opening 78, 79 for each of the two laser beams B1, B2, respectively. The solenoid 75 can rotate the member 77 between an open position in which the openings 78, 79 are generally in line with the beams B1, B2, and a closed position in which the beams B1, B2 are blocked by the member 77.

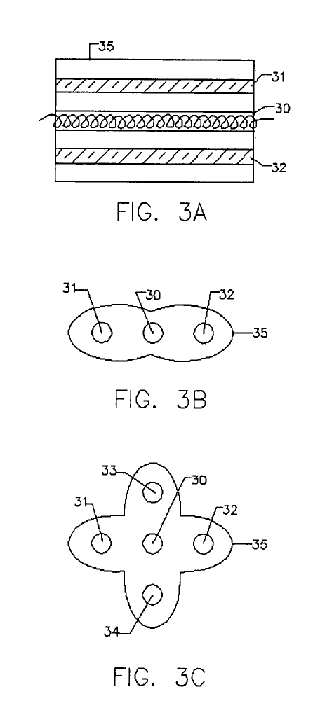

Further savings can be had by using a common excitation lamp for both lasers 11 and 12, as illustrated in FIGS. 3A and 3B. FIG. 3A shows a single excitation lamp 30 adjacent a first solid-state oscillator rod 31 and second solid-state oscillator rod 32 in a reflector housing 35. The first rod 31 is used by the first laser 11 while the second rod 32 is used by the second laser 12. FIG. 3B shows a cross section of the lamp/oscillator rod arrangement of FIG. 3A. As mentioned, other numbers of lasers can also be combined. FIG. 3C shows a cross section of an exemplary lamp/oscillator rod arrangement for a four-laser embodiment in which a lamp 30 is surrounded by four oscillator rods 31-34 in a reflector housing 35.

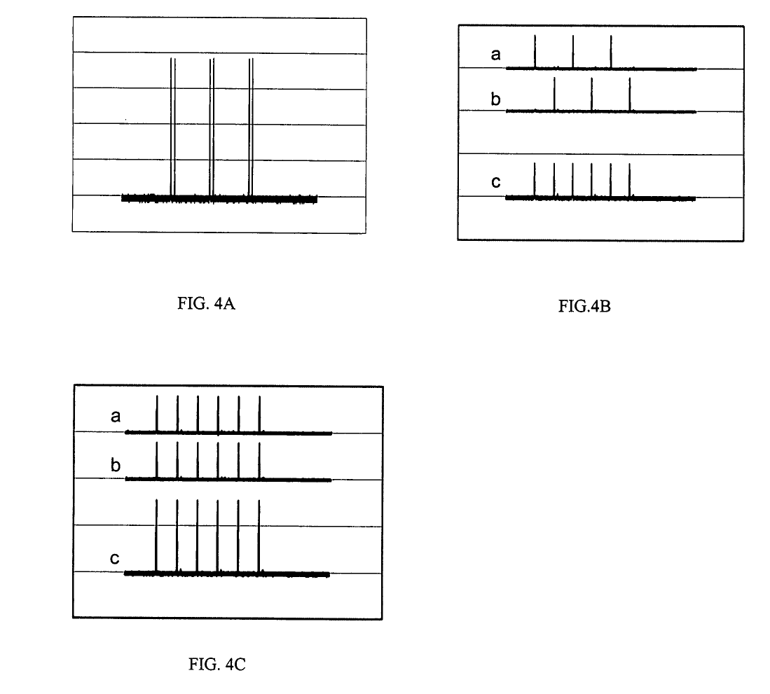

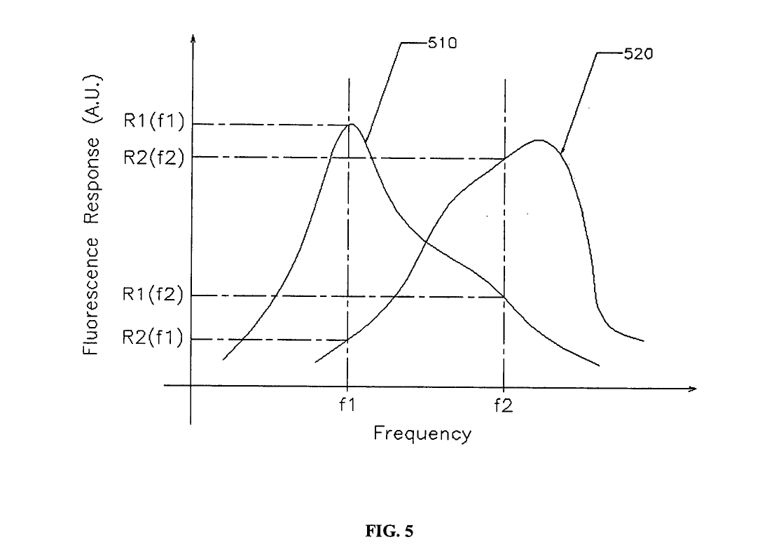

FIGS. 4A-C show examples of how the outputs of two pulse-generating lasers can be combined with a device of the present invention. As shown in FIG. 4A, pulse pairs can be generated for high speed and high resolution PIV applications. In FIG. 4B, the outputs of two lasers (a, b) are interlaced to double the pulse repetition rate and average power (c) achievable with one laser. For an N-headed device, the pulse repetition rate and average power can be increased N-fold. In FIG. 4C, the outputs of two lasers (a, b) are synchronized to double the pulse energy and peak power (c). For an N-headed device, the pulse energy and peak power can be increased N-fold by synchronizing the outputs of the N lasers.

In addition to combining pulsed lasers in a multi-laser device of the present invention, continuous wave (CW) lasers can also be combined with each other or with pulsed lasers.

The following table illustrates some of the parameters that can be selected for the lasers incorporated into a multi-laser device of the present invention.

TABLE I

| | | Fundamental | | Operating |
|---|---|---|---|---|
| Materials | Pumping type | Wavelength Band | Harmonics | mode |
| Nd:YAG | Arc lamp | Infrared (IR) | 1 | Pulsed |

| | |
|---|---|
| 1.064 | μm |
| 1.053 | μm |

| | | | | |
|---|---|---|---|---|
| Nd:YLF | Diode | Green | 2 | CW |

| | |
|---|---|
| 532 | nm |
| 527 | nm |

| | |
|---|---|
| Ultraviolet (UV) | 3 |

| | |
|---|---|
| 355 | nm |
| 351 | nm |

| | |
|---|---|
| Deep UV | 4 |

| | |
|---|---|
| 266 | nm |
| 263 | nm |

| | |
|---|---|
| Extremely deep UV | 5 |

| | |
|---|---|
| 213.5 | nm |
| 210.6 | nm |

For each laser, any parameter from one column can be combined with any parameter from another column. Thus, in effect, TABLE I represents a 2×2×10×5×2 matrix of 400 different lasers that can be used as each of N lasers in an N-headed device in accordance with the present invention.

In a further aspect of the present invention, the inventive multi-headed laser device can be used in novel ways in a variety of applications. One area in which the device of the present invention can be used is materials processing. Where one type of material is being processed, e.g., etching a metal, a dual-headed laser in accordance with the present invention can be used advantageously, with one laser acting as an “initiator” of the process and the second laser acting as a “driver” of the process. When a laser first acts upon the surface of a material, the initial linear coefficient of absorption of the material at the surface changes. The optimal absorption wavelength thereby changes, usually to a different wavelength. By providing a dual-headed laser in accordance with the present invention in which the first laser has a wavelength that is optimal for the initial absorption and in which the second laser has a wavelength that is optimal for the altered absorption, processing of the material can proceed by simultaneously or alternately applying the two laser beams to the material. The first or “initiator” laser initiates the laser-material interaction whereas the second “driver” laser drives the process of heating, melting or vaporizing the material.

In an exemplary embodiment, a low- to high-power Nd:YAG laser that is arc lamp or diode pumped, can be combined with a moderate- to high-energy per pulse Nd:YLF laser to take advantage of the high energy per pulse that the Nd:YLF laser can generate to rapidly start a material interaction and then to rely on the higher average power of the Nd:YAG laser to maintain the desired effect (e.g., heating, melting, vaporizing). For processing metals, for example, the initiator laser can have a wavelength in the green band, which is better suited for the absorption of most metals in their original state. For the driver laser in metal processing, a wavelength in the IR band is better suited to most metals after initial processing by a green laser. UV and deep UV are better suited for processing semiconductors, some ceramics and some polymers.

A device in accordance with the present invention can also be used advantageously to process multi-material systems. An example of such an application is the cutting of printed circuit boards or semiconductor wafers. A first laser can be used to remove the upper layer of a multi-layer structure, a second laser can be used to remove the second layer, and so on, with each laser being optimized for the material of the layer it is to process. For example, in a two-layer structure of glass over silicon, a 355 nm UV laser can be used to remove the glass whereas a 532 nm green laser can be used to process the silicon.

When processing materials using an initiator and a driver laser, the initiator laser should preferably be applied before the driver laser. This will allow the operation of the initiator laser to have its desired effect so that the driver laser can perform its task more effectively. The initiator and driver lasers can also operate simultaneously, with the initiator laser starting first and the driver laser starting some time later but while the initiator laser is still operating.

In another materials processing application of the present invention, a dual-head laser is used to heat and cut a temperature-sensitive material. Such a combination of functions can be used advantageously where extremely precise cuts are to be made in a material that expands with heat. An example of such an application is the manufacture of stents comprised of the alloy Nitinol. The first laser of a dual-head laser outputs laser radiation in the IR range and is used to heat selected areas of the item being processed. The heat causes the targeted areas of the item, comprised of a heat-sensitive material such as Nitinol, to enlarge. While enlarged, the second laser, which generates laser radiation in the green range (532 nm), for example, is used to make the desired cuts on the enlarged areas of the item. When the item cools to room temperature and shrinks to its original size, the resultant cuts will have a precision that is beyond that attainable had the cuts been made on the item in its original, room-temperature size.

The inventive multi-laser device of the present invention can also be used in materials analysis applications, such as laser-induced fluorescence (LIF). In LIF, optical emissions from atoms and molecules that have been excited to higher energy levels by absorption of electromagnetic radiation from a laser are detected in order to determine the composition of matter.

In an exemplary method of the present invention, it is desired to determine whether a rock contains a particular mineral, e.g., diamond. The rock is irradiated with a laser of a first wavelength which is selected so as to cause any diamond crystals in the rock to fluoresce. For example, laser radiation having a wavelength of 1064 nm will cause diamond to fluoresce. As the rock is irradiated, any fluorescence generated by the rock is detected and analyzed. If the detected fluorescence spectrum meets certain predetermined criteria indicative of diamond (e.g., it is within a predetermined range of values at one or more selected wavelengths), a determination is made that the rock contains diamond. In an exemplary embodiment of the present invention, the rock is then irradiated with a laser of a second wavelength using a dual-laser device to determine the quality of the diamond contained therein. As the rock is irradiated with the second laser, the fluorescence generated is detected and analyzed. If the detected fluorescence meets certain criteria, a determination is made that the diamond is of a high quality grade and if not, of a lower grade.

In an alternate embodiment, a multi-head laser of the present invention can be used to detect the presence of multiple materials in a given item. In this embodiment, each laser operates at a wavelength that is selected to cause fluorescence by a certain material. By successively irradiating a sample with each wavelength of laser and detecting the fluorescence induced by each, a determination can be made as to whether or not the materials are present in the sample.

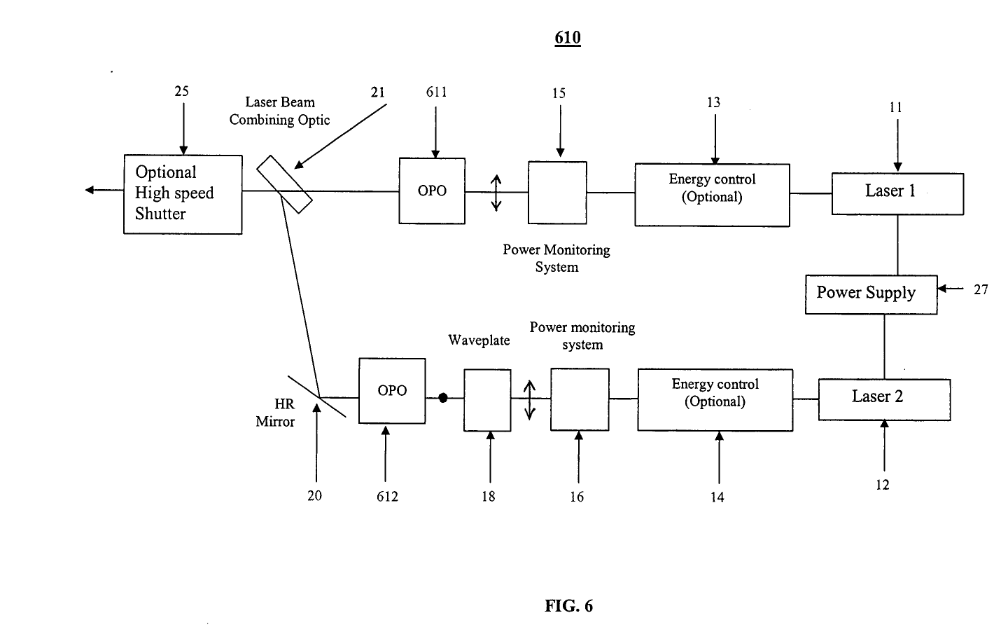

Furthermore, a determination of the composition of a sample can also be made by comparing the different fluorescence responses to the different wavelengths of laser used to irradiate the sample. For example, as illustrated in FIG. 5, a ratiometric comparison of the fluorescence responses can be made at two or more selected frequencies. Spectrum 510 represents the fluorescence response to a first wavelength laser and spectrum 520 represents the fluorescence response to a second wavelength laser. If the ratios R1(f1):R2(f1) and R2(f2):R1(f2) are within predetermined ranges, a determination can be made that the sample contains materials A and B in the proportions expected of a given composition.

Such materials analysis methods have wide applicability to both scientific and industrial applications.

A further materials analysis application for a multi-laser device of the present invention includes multi-beam laser chemistry or pump/probe spectroscopy. When materials composed of certain atoms are pumped or excited by laser radiation of a first wavelength, the excited atoms can be induced to create stimulated emission with a second laser of a second wavelength. The first laser may be referred to as a “pump” laser and the second laser may be referred to as a “probe” laser. When induced to create stimulated emission, an atom will emit a characteristic radiation that can be detected, such as by a photomultiplier tube (PMT) or the like. This information can be used together with the timing of short laser pulses to study the temporal behavior of molecular systems in greater detail.

Another type of spectroscopy in which the present invention can be advantageously employed is absorption spectroscopy. As is well known, materials exhibit absorption spectra that are characteristic of the materials' composition. The absorption exhibited by a material can be determined by irradiating the material with a laser beam, detecting how much of the incident laser beam leaves the material (using a PMT or the like) and comparing the two. With one laser of a fixed wavelength, the absorption of the material can be determined for only that wavelength. Determining the absorption spectrum for a material at only one point may be adequate for some applications. For other applications, however, it may be necessary or desirable to obtain more spectral information.

With an N-headed laser device in accordance with the present invention, the absorption spectrum of a material can be determined at N different wavelengths, simultaneously. Such information can give significant insights into the mechanics and behavior of certain molecules. For example, a two-headed laser such as that of FIG. 1, can be used to determine the absorption of nitric oxide (NO) at the fundamental wavelength of 226 nm as well as at the first overtone of 236 nm or at the second overtone of 246 nm, or any combination of two wavelengths.

Multiple points of the absorption spectra of materials can also be determined with a single laser whose wavelength can be varied. In this case, the absorption of a material is determined at multiple points as the wavelength of the incident laser is varied over a spectrum of interest. To vary the wavelength of a laser, an optical parametric oscillator (OPO) can be added in line with the output of the laser. An OPO uses non-linear optics to provide an output whose wavelength can be varied. Commercially available OPOs include the SURELITE, PANTHER and SUNLITE EX models of OPOs available from Continuum Electro-Optics, Inc. of Santa Clara, Calif. The spectral linewidth of the OPO that is best suited for a particular application will depend on the absorption spectra of the materials to be analyzed (i.e., the spacing of the characteristic features of the spectra).

While the addition of an OPO provides wavelength agility to a single laser, there may be applications, such as described above, in which it is desirable to determine the absorption of certain materials at two or more wavelengths simultaneously. FIG. 6 shows a further exemplary embodiment of a multi-laser device 600 of the present invention in which the wavelength of each laser is made tunable. The device 600 is similar to that of the FIG. 1 with the exception of the addition of an optical parametric oscillator (OPO) 611, 612 in line with the output of each of the lasers 11, 12. Therefore, with the OPOs 611, 612, the device 600 can output a first laser beam whose wavelength can be varied over a first range, combined with a second laser beam whose wavelength can be varied over a second range. The first and second ranges may or may not overlap, depending on the intended application.

As an alternative to using an OPO to provide wavelength variability, other devices that can be used include an optical parametric amplifier (OPA) or a dye laser.

In further embodiments of a multi-laser device in accordance with the present invention, one of the lasers can be provided with wavelength agility (such as described above) while the remaining lasers have fixed wavelengths; one of the lasers can have a fixed wavelength while the others are provided with wavelength agility; or any number of the lasers can be provided with wavelength agility.

It is to be understood that while the invention has been described above in conjunction with preferred specific embodiments, the description is intended to illustrate and not to limit the scope of the invention, as defined by the appended claims. Indeed, various modifications of the invention in addition to those described herein will become apparent to those skilled in the art from the foregoing description and the accompanying figures. Such modifications are intended to fall within the scope of the appended claims.

It is further to be understood that all values are to some degree approximate, and are provided for purposes of description.

The disclosures of any patents, patent applications, and publications that may be cited throughout this application are incorporated herein by reference in their entireties.

1. A multi-laser apparatus comprising:
a housing;
a first laser, the first laser generating a first laser beam of a first wavelength;
a second laser, the second laser generating a second laser beam of a second wavelength; and
a beam combiner, the beam combiner combining the first and second laser beams onto a common beam path.

2. The apparatus of claim 1 comprising:
a power supply, wherein the power supply provides power to the first and second lasers.

3. The apparatus of claim 1 comprising:
an excitation lamp, wherein the excitation lamp is shared by the first and second lasers.

4. The apparatus of claim 1 comprising:
waveplate, the waveplate rotating a polarization of at least one of the first and second laser beams.

5. The apparatus of claim 1 comprising:
a shutter, the shutter selectively blocking at least one of the first and second laser beams.

6. A materials processing method comprising:
irradiating a material with a first laser beam of a first wavelength; and
irradiating the material with a second laser beam of a second wavelength, wherein the first and second laser beams have a common beam path.

7. The method of claim 6, wherein the material is irradiated with the first and second laser beams at the same time.

8. A materials analysis method comprising:
irradiating a material with a first laser beam of a first wavelength;
determining a first fluorescence of the material in response to the first laser beam;
irradiating the material with a second laser beam of a second wavelength; and
determining a second fluorescence of the material in response to the second laser beam,
wherein the first and second laser beams have a common beam path.

9. The method of claim 8, wherein the material is irradiated with the first and second laser beams at the same time.

10. A materials analysis method comprising:
irradiating a material with a first laser beam of a first wavelength;
irradiating the material with a second laser beam of a second wavelength; and
determining an absorption of the first and second laser beams by the material,
wherein the first and second laser beams have a common beam path.

11. The method of claim 10 comprising:
changing the wavelength of the first laser beam; and
repeating the step of determining an absorption of the first laser beam with the changed wavelength.

12. The method of claim 10, wherein the material is irradiated with the first and second laser beams at the same time.

13. A materials analysis method comprising:
irradiating a material with a first laser beam, the first laser beam causing an excitation of the material;
irradiating the material with a second laser beam, the second laser beam causing a stimulated emission of the material; and
detecting the stimulated emission of the material, thereby determining a property of the material,
wherein the first and second laser beams have a common beam path.

14. The method of claim 13, wherein the material is irradiated with the first and second laser beams at the same time.

15. A multi-laser apparatus comprising:
a housing;
a first laser, the first laser generating a first laser beam of a first wavelength;
a second laser, the second laser generating a second laser beam of a second wavelength;
a first wavelength varying device, the first wavelength varying device being arranged in line with the first laser beam to vary the first wavelength over a first range of wavelengths; and
a beam combiner, the beam combiner combining the first and second laser beams onto a common beam path.

16. The apparatus of claim 15, wherein the first wavelength varying device comprises an optical parametric oscillator.

17. The apparatus of claim 15, wherein the first wavelength varying device comprises an optical parametric amplifier.

18. The apparatus of claim 15, wherein the first wavelength varying device comprises a dye laser.

19. The apparatus of claim 15 comprising:
a second wavelength varying device, the second wavelength varying device being arranged in line with the second laser beam to vary the second wavelength over a second range of wavelengths.

20. The apparatus of claim 19, wherein the first and second ranges of wavelengths overlap.
